(19) United States
(12) Patent Application Publication
(10) Pub. No.: US 2005/0161046 A1
(43) Pub. Date: Jul. 28, 2005

(54) Personal air purifier

(76) Inventor: Robert C. Michaels, Santa Barbara, CA (US)

Correspondence Address: FELIX L. FISCHER, ATTORNEY AT LAW, 1607 MISSION DRIVE, SUITE 204, SOLVANG, CA, 93463, US

(21) Appl. No.: 10/763,278

(22) Filed: Jan. 22, 2004

(51) Int. Cl. A62B 7/10; A62B 18/08

(52) U.S. Cl. 128/206.14

(57) ABSTRACT

A woven fabric mesh personal air purifier to be adhesively received to the face and nose. The present invention comprises a single layer of precision woven, polymer fabric with an integral, pressure-sensitive adhesive band coincident with the circumferential periphery of one side and where the square pore size determines the minimum size particulate rejected. The filter fabric adhesive creates a leak proof seal against the upper lip, face and nose thereby enclosing the nostrils. The area of the filter fabric is sufficient to compensate for the increased breathing resistance that will occur because the filtering element decreases the free access of airflow through the nostrils.

### BACKGROUND OF THE INVENTION

1. Field of the Invention

This invention relates generally to the field of air filtration and, more particularly, to a precision woven filter fabric die cut to a scaleable shape and adhesively joined to the face and nose to provide a seal that prevents airborne contaminates from entering the nasal system.

2. Description of the Related Art

The human body is insulted by many airborne contaminants including allergens, animal dander, house dust, mites, construction dusts, ragweed pollens, rye grass pollens and other environmental pollutants. The National Institute of Allergy and Infectious Diseases estimates that 35 million Americans are plagued by upper respiratory symptoms that in many cases are allergic reactions to the airborne contaminants that are breathed every day. This is a global problem as a recently published study in the European Respiratory Journal suggested that workplace exposure may cause as much as 31% of all cases of chronic obstructive pulmonary disease, which kills more than 100,000 Americans each year.

The respiratory system of the human body is the main route for entry of contaminants such as dusts and pollens. The respiratory system includes the nose and mouth, trachea, bronchi (branching airways), and alveoli (interior surface of the lungs). The human anatomy is designed to process the airborne impurities through the nose so that the air is purified, warmed and humidified before it reaches the lungs. The hairs and mucous membranes inside the nose normally trap large particles of dirt and allergens. The trapped dirt particulate are eventually blown out the nose or coughed up. Allergens, trapped by the mucous membranes sometime cause a reaction where histamine and other chemicals are released causing swelling and nasal congestion.

Under normal conditions, particulate that bypass the nasal hairs are trapped by the fluids produced in the mucous membranes of the windpipe and bronchi and moved to the mouth by the cilia (hairlike projections that move in unison). There the particulate and dust are coughed up and spit out or swallowed.

The human respiratory system can be overwhelmed if its capacity to process airborne impurities is exceeded. Given that healthy lungs take two to three days to clear themselves after overloading, it is evident that a personal air purifier to help remove inhaled allergens and particulate has great public value.

Personal Air Purifiers generally fall into two categories: type 1—those that cover both the nose and mouth and type 2—those that cover a portion of the nose or are insertable in the nostrils.

Regarding type 1, those that cover both the nose and mouth are uncomfortable because they trap heat and cause the face to sweat, especially during heavy exertion. They also make eating and drinking impossible, make talking difficult and make the use of spectacles both uncomfortable and dangerous due to fogging.

Regarding type 2, the prior art teaches a variety of partial nose covering gloves or nostril insertable filters. For example, those disclosed in U.S. Pat. Nos. 5,392,773; 5,485,826; 5,636,629; 5,740,798; 5,890,491; D461,890 S and 2002/0166556 A1.

U.S. Pat. No. 5,392,773, issued to Bertrand, teaches the use of a two part configuration consisting of a meshed filter region and a porous fabric adhesive region that together covers the nostrils. The adhesive component has distal, medial and proximal tabs that secure the filter while leaving the upper surface of the nose uncovered. Unlike the present invention, which is a single entity, there are two components, filter and adhesive. The adhesive component has four separate shapes that vary in width and length. Bertrand also teaches that the intertabular strips, one of the four shapes, are of a narrow dimension thereby appearing to allow leakage at the confluence of the medial and proximal tabs. Unlike the present invention which has an increased area determined by the percent open area of the precision woven fabric, Bertrand also teaches that the nostril area is just covered but does not discuss the increased breathing resistance that will occur because the filtering element decreases the free access of airflow through the nostrils.

U.S. Pat. No. 5,485,826 issued to Lincoln teaches the use of a filter element of cotton, wool, or such with specially designed dome or ellipsoidal shaped inserts that are held against the nostrils by two triangular strips of adhesive adhered to the nose. Unlike the unitary present invention there are many small pieces that must be attached to the main filter element. These protuberances may be inhaled into the nose and may damage sensitive nostrils. Unlike the present invention, the adhesive strips must be attached high on the sides of the nose and appear awkward and uncomfortable. In order to attach the protuberances securely to the nostril side of the filter media, the triangular end of the adhesive strip appears to be very high on the face almost touching the caruncle of the eye consequently offering the opportunity for irritation or damage to the eye. Unlike the present invention there is not an adhesive seal around the entire periphery of the filter media, specifically the upper lip (philtrum) thereby facilitating the passage of air between the filter media and the nostril (blowby).

U.S. Pat. No. 5,636,629 issued to Patterson, Jr. teaches the use of a nasal glove consisting of filter material circumscribed with a flexible material which is bent to conform to the shape of the exterior of the nose and hold the glove in place. Unlike the present invention that seals around the entire filter media periphery, there is no sealing at the juncture of the nostril and upper lip (philtrum) thereby allowing air to bypass the filter media. The filter media and efficacy is not well described and it is difficult for the glove to fit different size noses thereby facilitating blowby at the top and sides of the nose.

U.S. Pat. No. 5,740,798 issued to McKinney, teaches of an air filter covering the nostrils that consists of a filter element which is preferably made of a thermal fleece or a thermal undergarment material. This is held to the nose by a combination of an elastic strand and adhesive strips. Unlike the present invention, which utilizes a hypoallergenic pressure sensitive adhesive completely around the nose, it is extremely difficult to seal airflow to the nose with elastic bands thereby facilitating blowby. McKinney also teaches that a thermal undergarment material is a suitable filter material but does not identify the efficacy of such undergarment for filtration applications.

U.S. Pat. No. 5,890,491 issued to Rimkus, teaches that the flapper valve of U.S. Pat. No. 5,568,808 is not efficacious and that the nose filter housing and flange becomes fixedly attached inside the nostril through an adhesive component. Unlike the present invention the use of an adhesive on the sensitive membranes of the nose could be an irritant as well as painful when the housings are removed. Rimkus also teaches that the filter element fits inside the housing and is disposable. It appears the housings are not conformable to the inside of the nose and it is difficult for the housings to fit different size nostrils thereby facilitating blowby between the outside of the housing and the inside of the nose. Rimkus also teaches that although the filter media is disposable, the housings are reusable possibly leading to contamination from rhinoviruses, adenoviruses, parainfluenza, pollens and bacteria that may be present in the nose.

U.S. Pat. No. D461,890 S, Lawrence, teaches the use of an ornamental design for a nasal passage dust and pollen filter consisting of two essentially flat circular filter elements joined into a dumbbell shape by a non-filtering area encompassing a narrow septum clamp. The septum clamp consists of two proximal elements of narrow dimension which when squeezed by two fingers spreads two distal connected elements to open the clamp mechanism. When the two fingers are released, the distal clamp mechanism closes. Unlike the present invention, the use of a septum clip is painful and uncomfortable and may be impossible to use in the event of a deviated septum or other physiological aspect. The two filter elements do not seal against the nose, upper lip or face thereby allowing unfiltered air to be drawn into the respiratory system. The semi-rigid aspect of the filter elements with respect to the septum clamp limits the adaptability of the design to suit the nasal anatomy of different individuals.

U.S. Pat. Application Publication No. 2002/0166556 A1, Jacob, teaches the use of a nose airflow enhancer and filter holder consisting of a flexible plastic spring material with two self adhesive pads. The pads are intended to be affixed to and expand the nostrils by exerting outward pulling forces on the nostrils in the manner of external, adhesive nasal dilators while pressing the filter media against the nostrils. One end of the filter media, described as non-woven cotton or synthetics is attached to the flexible member and the other end is free. Unlike the present invention, which seals around the entire nose, there is no seal at the bottom of the nose or at the upper lip thereby facilitating blowby. Since the filter media is only attached to the plastic strip at one end, it is possible for air to pass around the filter during inspiration. Jacob teaches the immediate proximity of the filter media to the nostrils, but there is no mention of the increased breathing resistance that occurs because the filtering element decreases the free access of air through the nostrils.

None of the above referenced inventions either singly or in concert is seen to describe and explain the present invention.

A desired aspect of a personal air purifier is to provide a method for purifying the air inhaled through the nose by drawing the air through a soft precision woven filter fabric mesh die cut to an innovative scaleable shape and adhesively joined to the upper lip, face and nose. By providing a comfortable yet leak proof seal the woven fabric mesh effectively prevents airborne contaminates such as allergens, animal dander, house dust, mites, construction dusts, ragweed and rye grass pollens and many environmental pollutants from entering the respiratory system.

Unlike previous inventions, where the filter media is a separate piece affixed to another element or inserted into a housing, it is desirable that the purifier consist of approximately 50 micron thick filter fabric die cut into a shape designed to conform easily to the face while completely surrounding the nose. A wide band of medical grade pressure sensitive adhesive on the circumferential periphery of one side assures easy application and removal while providing a simple, yet effective leak proof seal.

It is desirable that the leak proof seal assures that all the air inhaled and exhaled through the nose passes through the soft filter fabric media. The shape of the filter fabric is configured to provide an increased area as determined by a calculation involving a normal nostril area and the percent open area of the woven filter fabric. If the total filter fabric area through which respiration takes place is not increased when a filtering element is used, increased breathing resistance will occur. The physical structure of the filtering element used in other devices actually decreases the free access of air through the nostrils. This increase in breathing resistance due to the filtering element is either not recognized or ignored in those inventions that apply filtering in close proximity to the nostrils.

Another desirable feature of a new and improved personal air purifier that when in place on the nose and face its appearance will be aesthetically pleasing. The soft, flexible filter fabric will affix easily to the face be comfortable during use and yet be easy to remove.

It is further desirable to provide a personal air purifier that will remain in place during eating, drinking, talking, heavy exertion and will allow spectacles to be used without fogging.

Additionally it is desirable to provide a personal air purifier that is easily manufactured, and intended for daily use thereby minimizing the opportunity to reinsert in the nose a unit contaminated with viruses, bacteria and allergens.

It is also desirable to provide a simple, low cost, disposable, portable personal air purifier that can be economically used by all members of society.

It is also desirable to apply the pressure sensitive adhesive to the face so that a complete leak proof seal encompassing the upper lip (philtrum), face, and nose is present thereby preventing blowby.

Further, it is desirable to provide a precision woven media whose shape and circumferential periphery adhesive affixes the filter media to the face in such a manner to encompasses a volume around the nose that represents a non-restricted area greater than that of the nostrils thereby assuring minimum face velocity and minimum breathing restriction.

Still further, it is desirable to provide a personal air purifier of the surface filter type that will capture and hold contaminates by screening and impaction filter mechanisms.

### SUMMARY OF THE INVENTION

The present invention incorporates a filter medium die cut to a specific shape with a wide strip of medical grade adhesive on the circumferential periphery of one side of the filter medium. A release liner covering the adhesive provides protection for the adhesive prior to use and is removed and discarded. The adhesive side is applied to the upper lip (philtrum), then to the face, then behind the flare of the nostrils (alar groove), then up and over the nose to repeat on the other side of the nose. Once in place the filter fabric encompasses a volume around the nose that represents a non-restricted area greater than that of the nostrils themselves. This assures a minimum face velocity at the filter surface and consequently the greatest efficiency.

The filter medium is a dielectric material that upon exposure to the air stream formed during the inhalation of air into the nostrils will generate an electrostatic charge that is capable of attracting and holding micron sized particulate and allergens.

The novel features which are considered characteristic for the invention are set forth in the description. The invention itself, however, both as to its construction and its method of operation, together with additional objects and advantages thereof, will be best understood from the following description of the specific embodiments when read and understood in connection with the accompanying drawings.

### BRIEF DESCRIPTION OF THE DRAWINGS

FIG. 1a is a front view showing the personal air purifier according to this invention in place on a user's face;

FIG. 1b is a front elevation view showing the adhesive circumferential sealing pattern of the personal air purifier of FIG. 1a;

FIG. 1c is a left side elevation view showing the adhesive circumferential sealing pattern of the personal air purifier of FIG. 1a;

FIG. 1d is a right side elevation view showing the adhesive circumferential sealing pattern of the personal air purifier of FIG. 1a;

FIG. 2 is a plan view of the personal air purifier of FIG. 1a and a magnified view of the precision woven filter fabric;

FIG. 3 is a front elevation section view of the personal air purifier of FIG. 2, the rear side elevation being a mirror image thereof;

FIG. 4 is a plan view of another embodiment that is the same as the present invention FIG. 2 except the filter fabric media is expanded microporous polytetrafluoroethylene (ePTFE) with a section of ePTFE shown at 2000 times magnification;

FIG. 5 is a plan view of another embodiment that is the same as the present invention FIG. 2 except the filter fabric media is non-woven dust mask or respirator material;

FIG. 6 is a front view showing yet another embodiment in place on the face;

FIG. 7 is a top, plan view of the personal air purifier of FIG. 6;

FIG. 8 is a front elevation section view of the personal air purifier of FIG. 6, the rear side elevation being a mirror image thereof; and,

FIG. 9 is a rear view of an alternative embodiment of the invention.

### DETAILED DESCRIPTION OF THE INVENTION

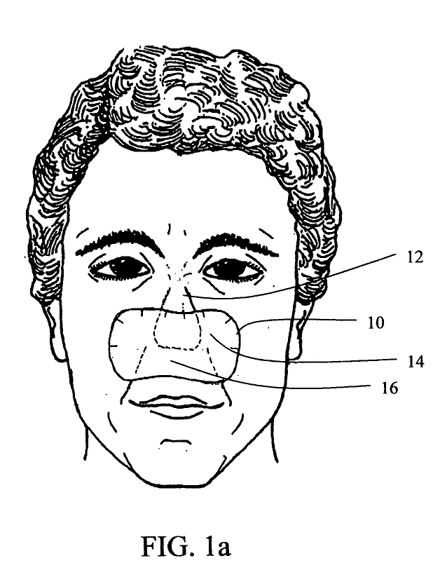

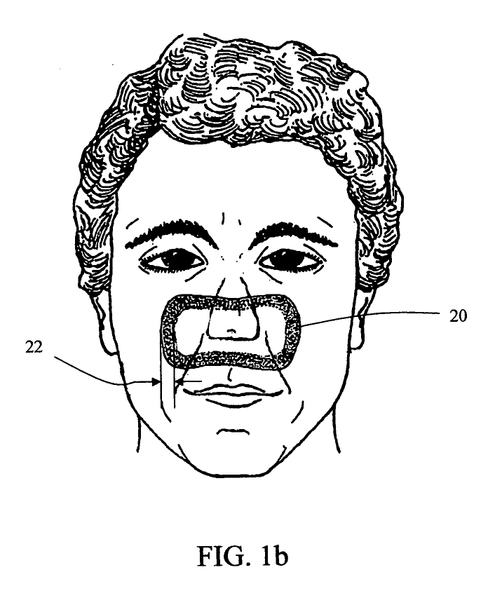

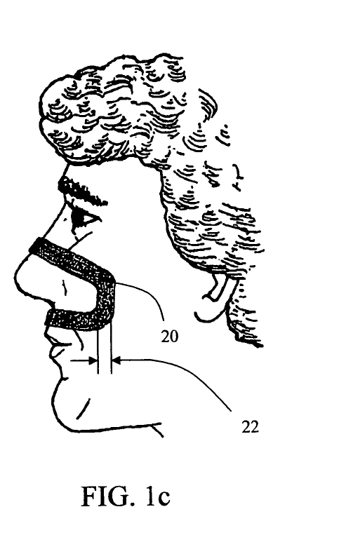

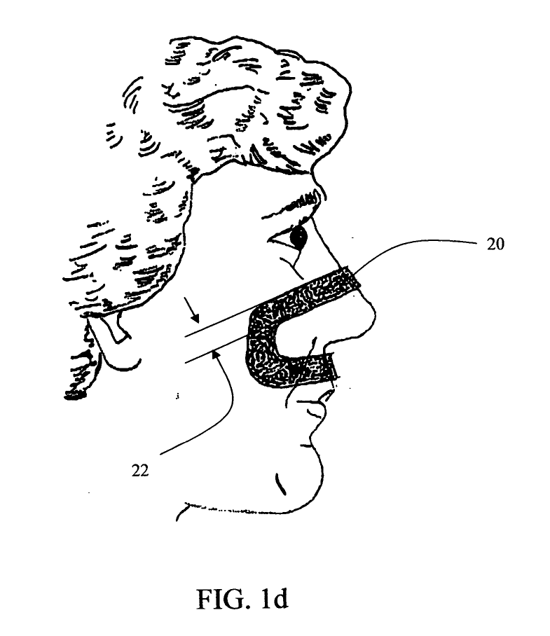

The personal air purifier employs a precision woven filter fabric media with a wide adhesive pattern on the circumferential periphery of one side. Referring to FIG. 1a, a personal air purifier 10 incorporating the present invention is shown as it is in place on the user's face. The extent of the filter fabric encompasses the philtrum 16, the area between the upper lip and the nose, thence to the face adjacent to the nose, thence to the area behind the alar groove 14 (flare of the nostrils), and thence to the sides and dorsum of the nose 12. The nostril openings are within the volume defined by the filter fabric.

The wide adhesive pattern on one side of the filter fabric assures that there is a leak proof seal between the fabric media and the skin about the periphery of the filter fabric medium. This large sealing area assures that nasal inspiration and exhalation must pass through the filter fabric media. In addition, the location of the adhesive at the dorsum area of the nose 12 and adjacent the alar groove 14 assures that the filter fabric will remain in place during normal activities such as talking, eating and heavy exertion. The dimensions of the personal air purifier assure that sufficient fabric is provided to afford a loose fit with the filter material lightly touching or slightly spaced from the skin of the nose.

The adhesive side is applied to the upper lip (philtrum), then to the face, then behind the flare of the nostrils (alar groove), then up and over the nose to repeat on the other side of the nose. Once in place the filter fabric encompasses a volume around the nose that represents a non-restricted area greater than that of the nostrils themselves. This assures a minimum face velocity at the filter surface and consequently the greatest efficiency.

Once applied, the filter fabric functions as a large area surface filter. A surface filter stops particles larger than the mesh pore size at the outside of the mesh and does not allow them to become entrained in the filter media. A depth filter by way of comparison, relies on tortuous paths through the filter to trap and hold contaminates. Filter operating mechanisms for surface filters include screening, where particles larger the clearance between the warp and weft cannot pass through and impaction where particles hit and stick to the warp and weft directly.

FIGS. 1b, 1c and 1d indicate the adhesive pattern 20 and the adhesive width 22 as if the present invention where in place on the face. As can be seen the sealing pattern assures that the nostril areas are captured within the sealed zone and that there is no area through which breathing air could bypass the filter material.

Because of the large volume (cubic inches) and surface area (square inches) created by the placement of the filter fabric adhesive, it is not necessary that inspired or exhaled air pass through the filter media in front of or even in proximity to the nostrils. Respiration may occur utilizing air drawn from anywhere on the filter fabric media that is not in the adhesive pattern 20.

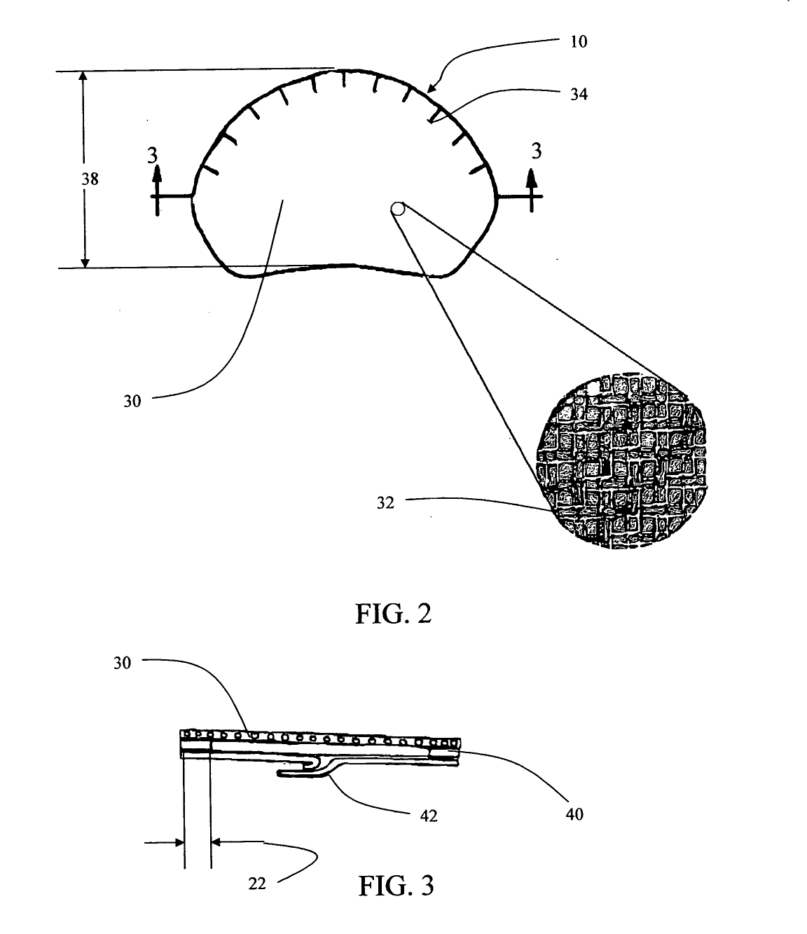

As depicted in FIGS. 2 & 3, a first embodiment of the present invention comprises precision woven fabric mesh 30 with a wide adhesive band 40 of width 22 on the circumferential periphery of one side. The band width provides the force necessary to affix the filter fabric to the face so that the leak proof seal will not be damaged or impaired during normal activities such as wearing spectacles, drinking or eating. Based on experimental results, it has been found that an adhesive width from 10 to 20 percent of the height 38 of the filter fabric provides the required strength yet is easily removable.

The adhesive used for the adhesive band 40 must have the ability to affix the filter fabric to the face and nose and provide a leak proof seal. Also the adhesive must release from the skin when the present invention is removed. Although several manufacturers are capable of producing an acceptable adhesive, it has been determined that the following 3M Medical Specialties, St Paul Minn. adhesives perform well—1509, 1512,1522 and 1524. These adhesives are hypoallergenic, conformable and have faceside adhesive strength in the 25 to 53 oz./in. range.

Referring again to FIGS. 2 & 3, the filtering element consists of precision woven fabric made from polyester, nylon or other polymers. Woven media has the advantage that it is non-shedding, dimensionally stable and is of high strength. The high strength allows the filter to be easily handled during manufacture and less likely to be damaged by the user. Sefar America Inc. Monterey Park, Calif. utilizing standard warp and weft techniques manufactures the media catalog numbers 6/5 to 105/52 that is used as the filter fabric in various embodiments of the invention. The intersection of the warp and weft threads produces a square opening or aperture size of consistent dimension as seen in the magnified view 32. Contaminates larger than the aperture size will not pass through the filter and will be rejected prior to being inhaled into the respiratory system.

Characteristics such as fiber size and number of fibers influence both the aperture size and percent open area. The percent open area can be thought of as the free area of the mesh, that area where there is no impediment to inspiration or exhalation. The catalog number of the mesh consists of two numbers the first being the aperture or pore size and the second the percent open area i.e. 30/21 or 20/13.

The area of filter fabric that is required for normal respiration may be calculated using the breathing area of the nostrils and the filter fabric percent open area. For example, given a median nostril size of 0.30″ by 0.60″ and a fabric open area of 21%, the calculation is 0.30″×0.60″=0.18 in² times 2 nostrils=0.360 in² divided by 21% fabric open area=1.71 in² required. As long as the filter fabric area is greater than the required area there will be no increase in breathing resistance.

Referring again to FIG. 2, there are multiple fitting slits 34 placed along the periphery that attaches to the face and nose. The fitting slits 34 facilitate the fit and conformance of the filter fabric and adhesive against the side and top of the nose.

The front elevation section view of FIG. 3 is taken from the section identified by line 3-3 of FIG. 2 and shows a section view of this embodiment of the invention. A release liner 42 protects the adhesive 40 from contamination and is removed prior to application. The release liner 42 in the present embodiment is the same die cut shape as the filter fabric 30. Referring to FIG. 3 again this embodiment of the invention is extremely conformable when applied because it is so thin. The filter fabric mesh, 50-90 microns (approximately 0.002″-0.004″), plus the adhesive strip (approximately 0.001″) results in a total thickness of approximately 0.005″. These dimensions may vary depending upon the fabric mesh and adhesive used.

The filter fabric mesh is a dielectric material that upon exposure to the air stream formed during the inhalation of air into the nostrils will generate an electrostatic charge that is capable of attracting and holding micron sized particulate and allergens.

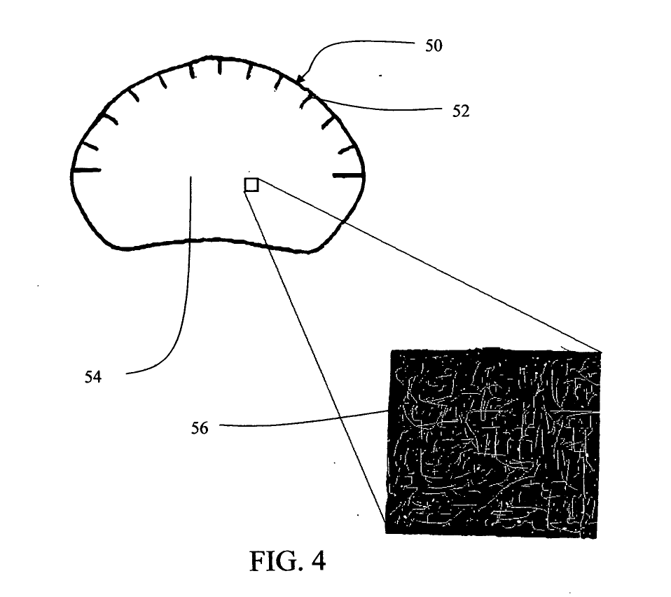

In another embodiment 50 depicted generally in FIG. 4, the filter membrane 54 is expanded microporous polytetrafluoroethylene (ePTFE) rather than the woven fabric 30 depicted in FIG. 2. The ePTFE membrane as seen in the 2000× magnified view 56 is capable of filtering micron sized particles while minimizing breathing resistance. The design criteria utilized for the personal air purifier 50 is the same as used for first embodiment of the invention, as previously described, including the fitting slits 52 and the wide adhesive band on the circumferential periphery of one side. Two manufacturers that are capable of producing the expanded microporous polytetrafluoroethylene for this personal air purifier embodiment 50 are WL Gore and Associates Elkton, Md. and Donaldson Tetratex, Bloomington, Minn.

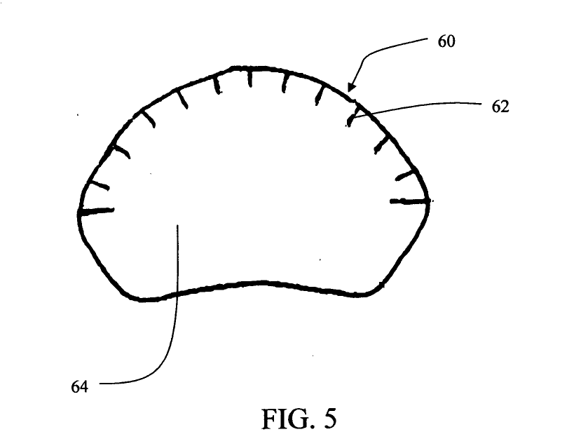

In another embodiment 60 depicted generally in FIG. 5, the filter material 64 is non-woven polyester media suitable for dust mask or comfort mask certification rather than the woven fabric 30 depicted in FIG. 2.

The design criteria utilized for the personal air purifier 60 is the same as used for the embodiments previously described, including the fitting slits 62 and the wide adhesive band on the circumferential periphery of one side. Because the filter material 64 is commonly used in dust masks and respirators there are many vendors capable of providing the material.

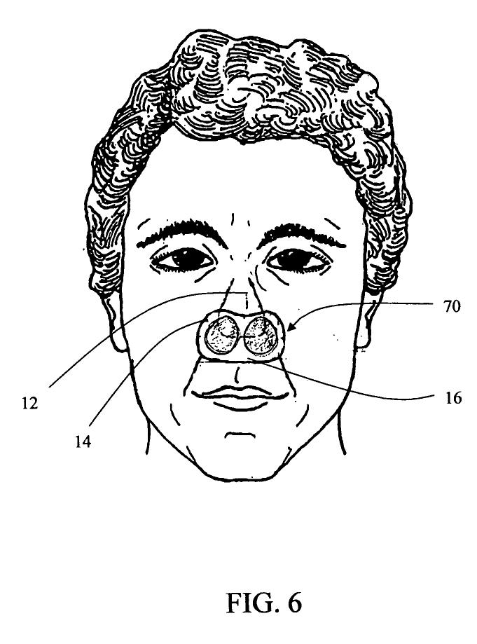

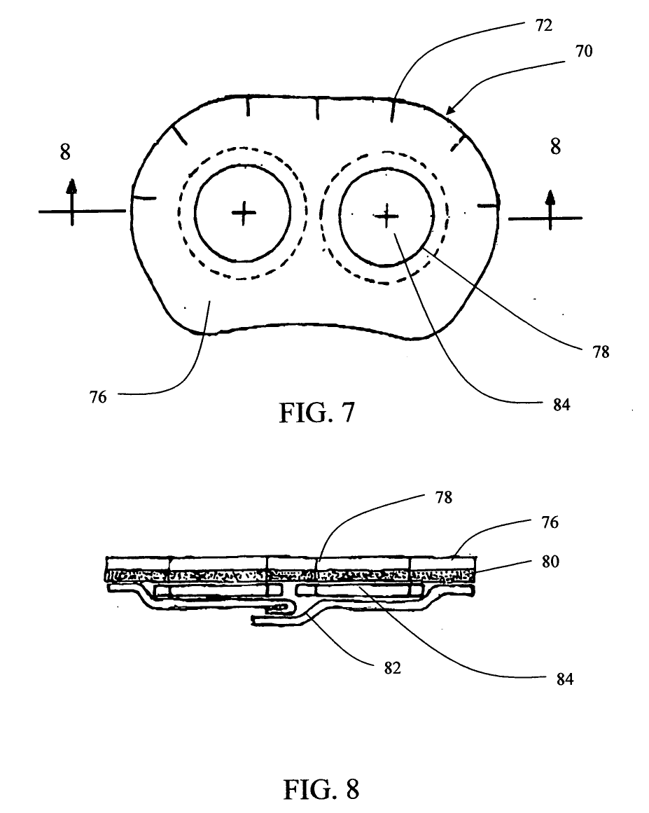

In yet another embodiment 70 generally depicted in FIG. 6 with the front elevation view FIG. 7. Two self-adhesive non-woven polyester technical vents 84 are affixed to the adhesive side 80 of adhesive tape 76. The tape 76 is affixed in place on the face in a manner similar to that of the embodiments previously described. Referring to FIG. 6, the adhesive side is applied to the philtrum 16, the area between the upper lip and the nose, thence to the face adjacent to the nose. The adhesive side 80 is tucked in to the area behind the alar groove 14 (flare of the nostrils), and thence to the sides and area of the dorsum of the nose 12 thereby surrounding the nostril openings within the volume defined by the adhesive tape 76. As in the previously described embodiments, there are multiple fitting slits 72 placed along the periphery that attaches to the face and nose. The fitting slits 72 facilitate the fit and conformance of the adhesive tape 76 against the side and top of the nose.

Referring to FIG. 8, the front elevation section view is taken from the section plane depicted by line 8-8 of FIG. 7. The release liner 82 covers and protects the adhesive side 80 of the adhesive tape 76 until the personal air purifier 70 is affixed to the face. The adhesive sides of two self-adhesive technical vents 84 are attached to adhesive side 80 of the adhesive tape 76 centered on the holes 78 in the adhesive tape 74.

The technical vents 84 are of a non-woven polyester design tested for dust penetration with 10 micron particles. They are manufactured by WL Gore and Associates Elkton, Md. and are sold for enclosure ingress protection against dust and dirt.

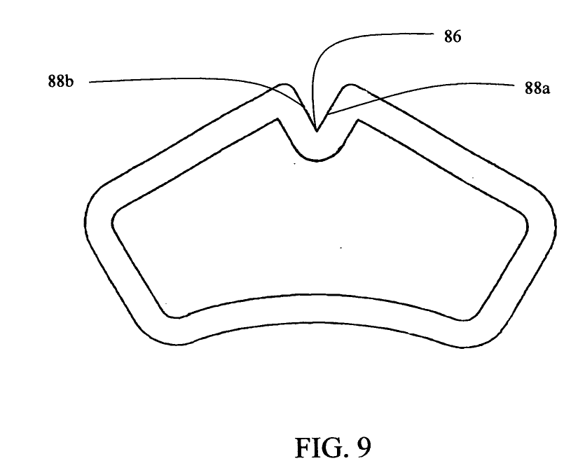

FIG. 9 shows another embodiment of the invention wherein the relief for gathering the periphery of the filter is provided by a V-groove or notch 86. When affixing the air purifier to the face, the top of the periphery is gathered to place the surfaces 88a and 88b of the notch adjacent to one another thereby providing a peaked shape to the filter element. This enhances the personal air purifier's fit to the user's nose and provides enhanced sealing around the periphery of the filter with minimal “pull” against the adhesive during use.

The adaptability of an innovative scaleable shape adhesively joined to the face combined with an integral high efficiency filtering element allows a nominal size to be suitable for many people. However, it is understood that the personal air purifier may be varied to accommodate other facial anatomy.

Having now described the invention in detail as required by the patent statutes, those skilled in the art will recognize modifications and substitutions to the specific embodiments disclosed herein. Such modifications are within the scope and intent of the present invention as defined in the following claims.

1. A personal air purifier for attachment to a user's face and nose comprising:
a filter medium having a periphery with a shape adapted to circumscribe a continuous perimeter including the philtrum, the face posterior to the left alar groove, the dorsum of the nose and the face posterior to the right alar groove;
an adhesive bonded to an interior surface of the filter medium proximate the periphery to sealingly bond the peripheral shape to the perimeter on the face, and,
wherein the filter medium and adhesive have a plurality of slits spaced about at least a portion of the periphery, each slit having a length less than a width of the adhesive strip, for fitting of the filter medium to the face about the perimeter.

2. (canceled)

3. A personal air purifier as defined in claim 1 wherein the slits are substantially perpendicular to the periphery.

4-9. (canceled)

10. A personal air purifier for a user's face comprising:
an adhesive tape having a first periphery with a shape adapted to circumscribe a continuous perimeter including the philtrum, the face posterior to the left alar groove, the dorsum of the nose and the face posterior to the right alar groove;
two technical vents each incorporating a filter medium affixed at a second periphery comprising two apertures to the adhesive tape inset from the first periphery, said adhesive tape bonding the first peripheral shape to the perimeter on the face and sealing the filter medium.

11. (canceled)

12. A personal air purifier as defined in claim 1 wherein the filter medium comprises a woven polymer fabric.

13. A personal air purifier as defined in claim 1 wherein the filter medium comprises a membrane of expanded microporous polytetrafluoroethylene (ePTFE).

14. A personal air purifier as defined in claim 1 wherein the filter medium comprises a non-woven polyester media.

15. A personal air purifier as defined in claim 1 wherein the filter medium is a dielectric material that upon exposure to an air stream formed during inhalation of air into the user's nostrils generates an electrostatic charge that is capable of attracting and holding micron sized particulate and allergens.

16. A personal air purifier as defined in claim 1 wherein filter medium encompasses a volume around the nose that provides a non-restricted area greater than an area defined by the user's nostrils.

17. A personal air purifier as defined in claim 1 further including a notch in the periphery substantially centrally located at a top of the periphery for drawing periphery adjacent the notch together at the bridge of the user's nose.
